(19) United States
(12) Patent Application Publication
(10) Pub. No.: US 2022/0398879 A1
(43) Pub. Date: Dec. 15, 2022

(54) METHOD FOR MONITORING AT LEAST ONE SENSOR

(71) Applicant: Robert Bosch GmbH, Stuttgart (DE)

(72) Inventors: Fabian Sasse, Ludwigsburg (DE); Jochen Vogt, Rosenberg (DE); Matthias Settele, Stuttgart (DE); Sandra Jauch, Renningen (DE); Zora Slavik, Heilbronn (DE)

(21) Appl. No.: 17/834,206

(22) Filed: Jun. 7, 2022

(30) Foreign Application Priority Data
Jun. 9, 2021 (DE) 10 2021 205 804.3

(51) Int. Cl. G07C 5/08; G07C 5/02

(52) U.S. Cl. CPC G07C 5/0808; G07C 5/02

(57) ABSTRACT

A method for monitoring at least one sensor in a vehicle. In the method, first data of the at least one sensor are compared to second data, which are provided by at least one further data source, and the function of the at least one sensor is assessed on the basis of this comparison.

### CROSS REFERENCE

The present application claims the benefit under 35 U.S.C. § 119 of German Patent Application No. DE 10 2021 205 804.3 filed on Jun. 9, 2021, which is expressly incorporated herein by reference in its entirety.

### FIELD

The present invention relates to a method for monitoring at least one sensor and an arrangement for carrying out the method.

### BACKGROUND INFORMATION

A sensor is to be understood as an electronic unit which is configured to detect technical variables, for example, physical or chemical variables, and to output a signal which carries a piece of information with respect to the detected variable.

In modern motor vehicles, a variety of different sensor systems are used for surroundings detection or surroundings perception.

One application of such sensors, in particular in heavy commercial vehicles is, for example, close-range protection, which is used to detect objects or persons in front of, on the side of, and behind the vehicle. It is to be taken into consideration here that the sensors used for this purpose may be impaired in their function by different influences.

For a high-performance system, it is to be ensured that actions are implemented to ensure that a restriction of the illumination or detection range of the sensors used may be recognized.

Existing approaches are concentrated in particular on recognizing a direct capping or covering of the sensor, for example, by ice, snow, dirt, etc. This is carried out in most cases using the employed sensor systems.

### SUMMARY

In accordance with the present invention, a method and an arrangement for monitoring at least one sensor are provided. Specific embodiments of the present invention are disclosed herein.

The provided method in acccordance with the present invention is used for monitoring at least one sensor in a vehicle, in particular a motor vehicle. In accordance with an example embodiment of the present invention, in the method, first data of the at least one sensor are compared to second data which are provided by at least one further data source. The function of the at least one sensor is assessed on the basis of this comparison. Function is understood herein in particular as the functionality of the sensor. This means that a statement is made about the extent to which the sensor is still suitable for the provided operation. If, for example, an attachment part causes a restriction of the detection range of the sensor, in this way the function and in particular also the functionality of the sensor is thus influenced or impaired.

The method provided herein is used in one embodiment for recognizing attachment parts, for example, tanks, cargo, bull bar, snowplow, reflector panels, special attachments, etc. which restrict, distort, or impair at least one sensor in its detection capability. Attachment parts in this case are also parts which are not only attached later, for example, assemblies, e.g., concrete mixers, crane assemblies, etc., which may also protrude into the field of view of the sensor. This may be achieved according to the method provided here with the aid of a mutually checking sensor system.

The described arrangement in accordance with the present invention is used to carry out the provided method and is implemented, for example, in hardware and/or software. This arrangement may moreover be integrated into a control unit, typically of a vehicle, or may be designed as such.

A focal point of the provided method is the comparison of various combinations of different data sources, which are also referred to as layers herein. In one example design, these jointly have the result that particular attachment parts may be recognized at a vehicle, for example, a truck. The sensory image of the surroundings may thus be compared, for example, to map representations, in order to recognize shadowing of the sensors by special attachment parts.

Layers include sensor data, data of a localization, historical data, and data in conjunction with static and dynamic vehicle properties:
Sensor data include pieces of information which may be taken from various sensor technologies located on board, e.g., front camera, close-range camera, front radar, corner radar, ultrasound, LIDAR, vehicle motion positioning sensor, and may be fused. This may take place, for example, within the scope of a surroundings detection, a situation analysis, and on the basis of movement profiles and typical roadside structures.
Localization includes, for example, pieces of information such as GPS data (GPS: global positioning system), typical roadside structures, radar road signature, and map data.
Static and dynamic vehicle properties include pieces of information on vehicle data, characteristic motion data, states or data of the various components of the drivetrain, the steering system, and the brakes, and vehicle dimensions, typically without attachment parts.

The described layers may be used all together or in parts, possibly also individually, for recognizing attachment parts or a sensor degradation due to vehicle parts or attachment parts.

In one example design, all possibilities with respect to the probability of an impairment due to attachment parts or vehicle parts are evaluated and the probabilities are used for an overall assessment. It is also possible to supply the individual probabilities or individual assessments of all or parts of the described possibilities to a learning network for an overall assessment.

Further advantages and designs of the present invention result from the description and the figures herein.

The above-mentioned features and the features still to be explained hereinafter are usable not only in the particular specified combination but also in other combinations or alone, without departing from the scope of the present invention.

### BRIEF DESCRIPTION OF THE DRAWINGS

FIG. 1 shows a temporally synchronous analysis and a temporally asynchronous analysis on the basis of a vehicle, in accordance with an example embodiment of the present invention.

FIG. 2 shows a schematic view of a vehicle including an arrangement for carrying out a method in accordance with an example embodiment of the present invention.

FIG. 3 shows a possible sequence of the provided method in a flowchart, in accordance with an example embodiment of the present invention.

### DETAILED DESCRIPTION OF EXAMPLE EMBODIMENTS

The present invention is schematically shown on the basis of specific embodiments in the figures and is described in greater detail hereinafter with reference to the figures.

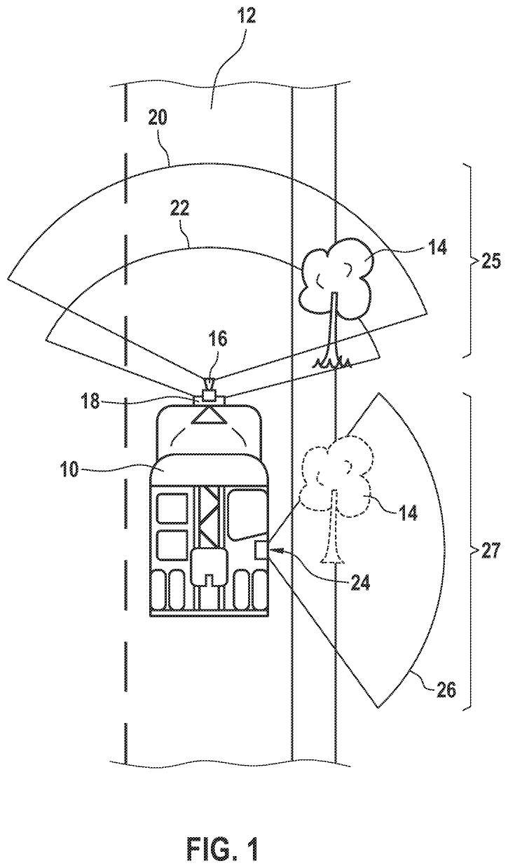

FIG. 1 shows a temporally synchronous and asynchronous analysis. The representation shows a vehicle which is identified as a whole by the reference numeral 10 and which travels on a roadway 12. Furthermore, objects 14 are apparent, in this case trees.

Vehicle 10 includes a front camera 16 and a front radar device 18. Front camera 16 provides a first detection range 20 and front radar device 18 provides a second detection range 22. These two detection ranges 20 and 22 are used for a temporally synchronous analysis 25.

Furthermore, a side radar device 24 is provided, which provides a third detection range 26. This third detection range 26 in combination with first detection range 20 and/or second detection range 22 is used for a temporally asynchronous analysis 27, which may be carried out alternatively or additionally to a synchronous analysis 25.

In the synchronous analysis, it is checked whether objects in the overlapping field of view of two or more sensors are detected by both sensors. If this is not the case, one of the sensors is possibly hidden. The asynchronous analysis uses the characteristic motion information of the vehicle to predict the motion of the object and then to check whether the object is detected by the sensor at the predicted point in time.

1. In a first specific embodiment of the present invention, sensor data are thus available as a further data source.

If two or more sensors are available in a vehicle for surroundings detection, for example, radar sensors and video cameras, their depictions of the surroundings may thus be compared to one another. Restrictions of the detection capability or the sensor field of view of these sensors may be derived therefrom. It may advantageously be ascertained whether objects of the real surroundings of the vehicle which are perceptible by the observed sensors are also seen by both sensors.

The following is carried out for the temporally synchronous analysis:

In the case of overlapping sensor fields of view of the observed sensors, it is compared whether all objects in the overlapping part of the sensor fields of view of the observed sensors are detected by all observed sensors. If objects are not detected by individual sensors or by one individual sensor this thus indicates a restriction of the detection capability of this sensor in the part of the field of view in which the object was detected by other sensors. It is to be noted that if the nature of the impairing surroundings influences is unclear, it may not be reliably ascertained which sensor system correctly reproduces its surroundings. Therefore, a configuration having more than two different or at least differently positioned sensors is advantageous.

The following is carried out for the temporally asynchronous analysis:

Pieces of information from nonoverlapping parts of the sensor fields of view of the observed sensors may also be used to ascertain restrictions of the detection capability or restrictions of the sensor field of view of individual sensors. It may be ascertained in this case during the trip whether objects which were detected by one or multiple sensors are also detected by other sensors having a differing field of view.

As soon as the vehicle has moved further in such a way that these objects are expected in the nominal field of view of the other sensors, a statement may be made about their detection. Both static and also moving objects may be used for this purpose. However, static objects offer the advantage of simpler reproducibility of their expected position relative to the ego vehicle or the nominal sensor fields of view. If expected objects are not detected by one of the sensors in an arbitrarily large part of the field of view, this thus indicates a restriction of the detection capability in this sensor field of view.

2. In a second specific embodiment, localization data are available as a further data source.

The localization approach compares the presently detected surroundings to a reference image in order to recognize field of view restrictions.

If pieces of information about its surroundings are available in a vehicle, for example, in the form of map data and a GPS localization of the vehicle, these may be used to infer an impairment of the detection capability of a sensor for surroundings detection installed at the vehicle.

The pieces of surroundings information obtained from the sensor signals may be compared over time to these externally contributed pieces of surroundings information. In this way, it may be ascertained whether the affected sensor is partially or even completely restricted in its detection capability.

If an object is not recognized at the position, which is typically stored in an external database, an impairment of the detection capability may thus be inferred. Those objects are preferably observed which have a unique signal signature with respect to the sensor system used. This may be provided, for example, by a high backscattering cross section of the radar.

The process chain may be constructed as follows:
1. Pieces of external surroundings information from a database are used, which are presently in the nominal sensor field of view.
2. These pieces of surroundings information are compared to the measured pieces of surroundings information of the sensor.
3. If 1 and 2 do not coincide, an impairment of the detection capability in the part of the sensor field of view in which the expected surroundings information was not detected may be inferred.

A specific example is given hereinafter:

A radar sensor is installed laterally at a vehicle and the vehicle is located on the right lane of a road in front of an intersection including a traffic light. In this situation, the traffic light is to be expected at a specific GPS coordinate from the pieces of information from the database. If this coordinate is located in the nominal sensor detection range and if the sensor does not detect the traffic light, it may thus be inferred that the sensor is restricted in its detection capability in the part of the sensor field of view in which the traffic light is located.

To increase the stability of the method it may be provided that multiple objects are observed, possibly also over time, and the piece of information obtained therefrom about the sensor restriction is averaged suitably.

The described method may be used both for one and also for multiple sensors. Furthermore, one or multiple external surroundings information sources may be used in combination, for example, map data and GPS localization. Furthermore, data may also be used which contain surroundings data detected directly by a sensor system combined with GPS coordinates, for example, a so-called radar road signature, pieces of information on road condition and type, repeatedly detected surroundings profiles. The term radar road signature includes characteristic measured radar reflections, reflection points, and/or radar landmarks.

The last-mentioned point is to be understood, for example, to include commercial vehicles, which often carry out repeating tasks with little variance in the route which is regularly covered. This applies in particular to parcel services or garbage collection trucks, but also to construction site vehicles which are used for a specific construction site. If the sensor system recognizes that there are only minor changes in the regularly detected surroundings, deviations in the surroundings detection with respect to otherwise regularly detected noticeable landmarks may be understood as an indication of a shadowing of the sensor.
3. In a third specific embodiment, static and/or dynamic vehicle properties are used as a further data source.

If pieces of information about characteristic variables of the vehicle geometry and the vehicle statics or dynamics are available in a vehicle, for example, the vehicle center of gravity or parameters of the pitch and roll behavior, these may be used to infer attachment parts. For this purpose, a deviation or change of these parameters may be compared for specific attachments, for example, attachment dimensions, weights, and positions. If the change of the measured parameters corresponds within an error tolerance to the parameters stored for an attachment type, it may be assumed that this type is installed.

In a further specific embodiment, measured deviations of the parameters are compared to corresponding threshold values. If these threshold values are exceeded, an attachment part which is not specified in greater detail may thus be presumed.

Variants include the use or the comparison of one parameter and also multiple parameters in combination. It is also possible to supply the results of the comparison of all or parts of the observed vehicle parameters to a learning network for the purposes of an overall assessment.

Possible measured variables are, for example:
Microvibrations due to a snow remover blade, a snowplow, or a snowblower,
Vehicle rolling due to mowing and cleaning attachments, crane attachments, or general protruding attachments,
Intrinsic pitch and roll behavior and longitudinal and lateral jerks during different driving maneuvers.

A specific example is given hereinafter:

For a snow plow attached to the front side of a commercial vehicle, it is characteristic that this causes a shift of the center of gravity of the vehicle in the direction of the vehicle front. If such a shift of the vehicle center of gravity is detected and this corresponds in its value within an error tolerance to a parameter stored for such a type of attachment, it is established and possibly reported that such an attachment is present on the vehicle. In a further embodiment, the value of the measured shift is compared to a threshold, from which an attachment present on the vehicle may be presumed.

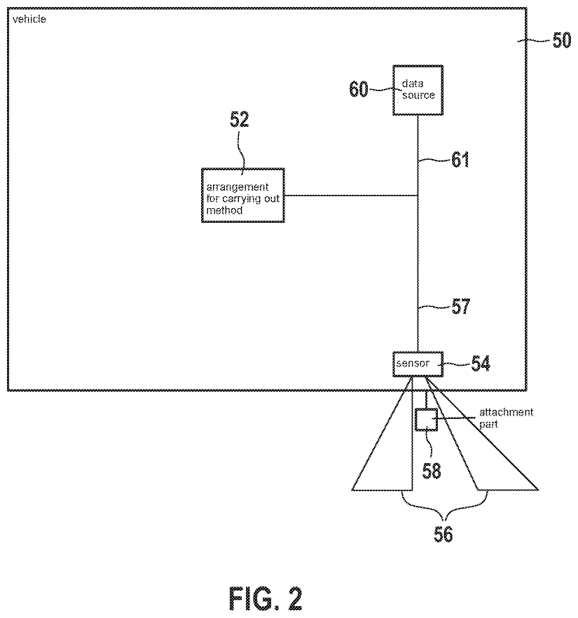

FIG. 2 shows a simplified, schematic representation of a vehicle 50, which is equipped with an arrangement 52 for carrying out the method provided herein. Vehicle 50 includes a sensor 54, which has a detection range 56, for which first data 57 may be obtained. It is apparent that detection range 56 is influenced or impaired by an attachment part 58, i.e., detection range 56 is partially hidden and thus reduced. This attachment part 58 thus has an effect on the function or functionality of sensor 50.

Furthermore, a further data source 60 is shown which provides second data 61. These second data 61 are compared to first data 57 in arrangement 52. In this way, it may be detected that attachment part 58 is present. It may possibly also be established what this is, attachment part 58 may thus be specified or identified. It is thus possible to describe the attachment part with respect to dimensions or a dynamic characteristic or to name this attachment part.

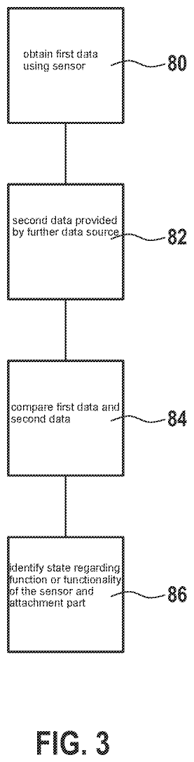

FIG. 3 shows a possible sequence of the provided method in a flowchart. In a first step 80, first data are obtained using a sensor. In a second step 82, second data are provided by a further data source. The first data and the second data are compared to one another in a third step 84 and then, in a fourth step 86, a statement is made about the function or functionality of the sensor and an attachment part is possibly identified. Of course, it is possible to also take into consideration more than two data sources.

What is claimed is:

1. A method for monitoring at least one sensor in a vehicle, the method comprising the following steps:
comparing first data of the at least one sensor to second data provided by at least one further data source; and
assessing a function of the at least one sensor based on the comparison.

2. The method as recited in claim 1, further comprising:
recognizing at least one attachment part at the vehicle.

3. The method as recited in claim 2, further comprising:
evaluating possibilities with respect to a probability of an impairment by the at least one attachment part.

4. The method as recited in claim 1, wherein at least one further sensor is used as at least one of the at least one data source.

5. The method as recited in claim 4, wherein a synchronous analysis is carried out.

6. The method as recited in claim 4, wherein an asynchronous analysis is carried out.

7. The method as recited in claim 1, wherein historic data are used as at least one of the at least one data source.

8. The method as recited in claim 1, wherein at least one localization is used as at least one of the at least one data source.

9. The method as recited in claim 1, wherein at least one vehicle property is used as at least one of the at least one data source.

10. The method as recited in claim 9, wherein at least one static vehicle property is used.

11. The method as recited in claim 9, wherein at least one dynamic vehicle property is used.

12. An arrangement for monitoring at least one sensor, the arrangement being configured to:
compare first data of the at least one sensor to second data provided by at least one further data source; and
assess a function of the at least one sensor based on the comparison.
